(19) United States
(12) Patent Application Publication
(10) Pub. No.: US 2022/0172185 A1
(43) Pub. Date: Jun. 2, 2022

(54) INFORMATION PROCESSING SERVER, INFORMATION PROCESSING METHOD, STORAGE MEDIUM, AND SERVICE PROVISION SUPPORT SYSTEM

(71) Applicant: HONDA MOTOR CO., LTD., Tokyo (JP)

(72) Inventors: Hodaka Mukohara, Tokyo (JP); Shumpei Suzuki, Tokyo (JP); Kobue Nose, Tokyo (JP)

(73) Assignee: HONDA MOTOR CO., LTD., Tokyo (JP)

(21) Appl. No.: 17/673,288

(22) Filed: Feb. 16, 2022

Related U.S. Application Data
(63) Continuation of application No. PCT/JP2019/033957, filed on Aug. 29, 2019.

(51) Int. Cl. G06Q 20/08; G06Q 20/10; G06Q 20/14; G06Q 20/38

(52) U.S. Cl. CPC G06Q 20/0855; G06Q 20/389; G06Q 20/14; G06Q 20/102

(57) ABSTRACT

An information processing server manages periodic payment of a plurality of users belonging to a group. The server sets a predetermined personal amount to be paid on a predetermined due date by each of the plurality of users and acquires information indicating payment amounts respectively designated by the plurality of users for each predetermined due date. The server determines, in a case where the information includes a first payment amount of a first user exceeding the predetermined personal amount and a second payment amount of a second user not satisfying the predetermined personal amount, deemed payment amounts of the first user and the second user such that the second payment amount is complemented by a part of the first payment amount.

### CROSS-REFERENCE TO RELATED APPLICATION(S)

This application is a continuation of International Patent Application No. PCT/JP2019/033957 filed on Aug. 29, 2019, the entire disclosures of which is incorporated herein by reference.

### BACKGROUND OF THE INVENTION

### Field of the Invention

The present invention relates to an information processing server, an information processing method, a storage medium, and a service provision support system.

### Description of the Related Art

In general, in the case of purchasing an expensive vehicle such as a motorcycle or a four-wheeled vehicle, a loan can be used in which a purchase amount is divided, and a fixed amount is paid periodically. For example, Patent Literature 1 discloses a technique of determining both the amount of loan repayments of a vehicle purchase price and the amount of loan repayments of a driving school fee related to acquisition of a driver's license and providing the determined amounts to an operation terminal. According to such a technique, it is possible to improve convenience of a user who is considering acquisition of a driver's license and purchase of a vehicle using a loan.

### CITATION LIST

### Patent Literature

PTL 1: Japanese Patent No. 6518824

### SUMMARY OF INVENTION

### Technical Problem

Incidentally, conventional loans and rentals are based on a premise that a user performs periodic payment alone. For this reason, a risk may be high for a user who has an ability to pay a loan or a rental fee in consideration of an average payment ability but has a payment ability fluctuating due to a large fluctuation in the revenue of a payment period (for example, every day, every month) for each payment, and it may be difficult to use the loans and rentals.

The present invention has been made in view of the above problems, and an object thereof is to realize a technique capable of further reducing a risk in payment for a user having a fluctuating payment ability.

### Solution to Problem

In order to solve the aforementioned issues, one aspect of the present disclosure provides an information processing server which manages periodic payment of a plurality of users belonging to a group, the server comprising: one or more processors; and a memory storing instructions which, when the instructions are executed by the one or more processors, cause the information processing server to function as: a setting unit that sets a predetermined personal amount to be paid on a predetermined due date by each of the plurality of users; an acquisition unit that acquires information indicating payment amounts respectively designated by the plurality of users for each predetermined due date; and a determination unit that determines, in a case where the information acquired by the acquisition unit includes a first payment amount of a first user exceeding the predetermined personal amount and a second payment amount of a second user not satisfying the predetermined personal amount, deemed payment amounts of the first user and the second user such that the second payment amount of the second user is complemented by a part of the first payment amount of the first user.

Another aspect of the present disclosure provides an information processing method executed in an information processing server which manages periodic payment of a plurality of users belonging to a group, the method characterized by comprising: setting a predetermined personal amount to be paid on a predetermined due date by each of the plurality of users; acquiring information indicating payment amounts respectively designated by the plurality of users for each predetermined due date; and determining, in a case where the information acquired by the acquiring includes a first payment amount of a first user exceeding the predetermined personal amount and a second payment amount of a second user not satisfying the predetermined personal amount, deemed payment amounts of the first user and the second user such that the second payment amount of the second user is complemented by a part of the first payment amount of the first user.

Still another aspect of the present disclosure provides a non-transitory computer readable storage medium storing a program for causing an information processing server which manages periodic payment of a plurality of users belonging to a group to execute each step of an information processing method, the method comprising: setting a predetermined personal amount to be paid on a predetermined due date by each of the plurality of users; acquiring information indicating payment amounts respectively designated by the plurality of users for each predetermined due date; and determining, in a case where the information acquired by the acquiring includes a first payment amount of a first user exceeding the predetermined personal amount and a second payment amount of a second user not satisfying the predetermined personal amount, deemed payment amounts of the first user and the second user such that the second payment amount of the second user is complemented by a part of the first payment amount of the first user.

Yet still another aspect of the present disclosure provides a service provision support system which includes an information processing server which manages periodic payment of a plurality of users belonging to a group and a plurality of communication devices, wherein the plurality of communication devices are associated with the plurality of users, respectively, and the information processing server includes one or more processors; and a memory storing instructions which, when the instructions are executed by the one or more processors, cause the information processing server to function as: a setting unit that sets a predetermined personal amount to be paid on a predetermined due date by each of the plurality of users, an acquisition unit that acquires information indicating payment amounts respectively designated by the plurality of users for each predetermined due date, and a determination unit that determines, in a case where the information acquired by the acquisition unit includes a first payment amount of a first user exceeding the predetermined personal amount and a second payment amount of a second user not satisfying the predetermined personal amount, deemed payment amounts of the first user and the second user such that the second payment amount of the second user is complemented by a part of the first payment amount of the first user.

### Advantageous Effects of Invention

According to the present invention, it is possible to provide a technique capable of further reducing a risk in payment for a user having a fluctuating payment ability.

### BRIEF DESCRIPTION OF DRAWINGS

The accompanying drawings, which are incorporated in and constitute a part of the specification, illustrate embodiments of the invention and, together with the description, serve to explain principles of the invention.

FIG. 1 is a diagram illustrating an example of a service provision support system according to the present embodiment of the present invention.

FIG. 2 is a block diagram illustrating a functional configuration example of an information processing server according to the present embodiment.

FIG. 3 is a block diagram illustrating an example of a software configuration of the information processing server according to the present embodiment.

FIG. 4 is a block diagram illustrating a functional configuration example of a user communication device according to the present embodiment.

FIG. 5 is a flowchart illustrating a series of operation steps of a payment amount control process according to the present embodiment.

FIG. 6 is a flowchart illustrating a series of operation steps of a total payment amount determination process according to the present embodiment.

FIG. 7 is a flowchart illustrating a series of operation steps of a payment process for each user according to the present embodiment.

FIG. 8 is a diagram illustrating an example of payment information of a first user belonging to a group according to the present embodiment.

FIG. 9 is a diagram illustrating an example of payment information of a second user belonging to the group according to the present embodiment.

FIG. 10 is a diagram illustrating an example of a payment amount input screen according to the present embodiment.

### DESCRIPTION OF EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

[System Overview]

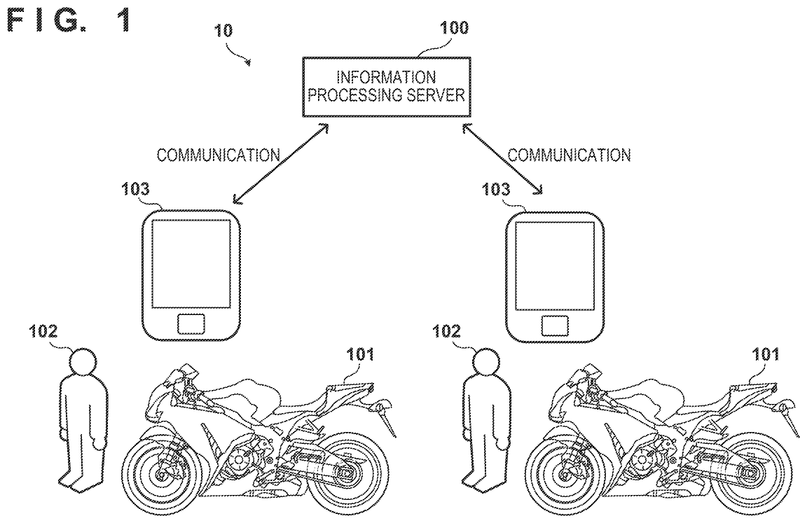

FIG. 1 is a diagram illustrating a configuration example of a service provision support system according to the present embodiment. A service provision support system 10 according to the present embodiment includes an information processing server 100 and a user communication device 103 used by a user 102. Here, the information processing server 100 is configured to communicate with a plurality of user communication devices 103 respectively used by a plurality of users 102.

The information processing server 100 is a server managed by a service provider, performs a payment amount control process to be described later, and manages periodic payment by a plurality of users belonging to a group. Although details of the payment amount control process will be described later, a payment amount (also referred to as a deemed payment amount) considered to be paid by each user 102 is controlled on the basis of a payment amount (also referred to as an actual payment amount) paid by each user 102 (for example, via the user communication device 103). In the payment amount control process described below, the individual user 102 periodically makes an individual payment. In one payment timing, in a case where the payment amount (actual payment amount) of the user exceeds a predetermined payment amount to be paid, it is possible to complement the payment amount of another user in the group that does not exceed a payment amount to be paid. As described above, when the payment is complemented at each payment timing among the plurality of users forming the group, it is possible to reduce a probability that the payment of an individual user does not satisfy a required amount and to reduce a risk of payment even for a user having a fluctuating payment ability.

In the present embodiment, the service provider rents the vehicle 101 to the user 102. The user 102 makes a predetermined amount of payment to the service provider in consideration of the rental service at predetermined periods (for example, every day, every week, and every month).

The payment made by the user 102 to the service provider may be made in currency of the country in which the service is performed, but virtual currency or points issued and managed by the service provider or a third party may be used.

The vehicle 101 is, for example, a two-wheeled vehicle, and can carry one customer in addition to the user 102 who is a driver. The vehicle 101 may be able to communicate with the information processing server 100, and can transmit data (also referred to as traveling data) such as acceleration collected by a sensor of the vehicle 101 to the information processing server at any time or at a predetermined timing. The traveling data will be described below. Note that a case where the vehicle 101 is a two-wheeled vehicle will be described as an example in the present embodiment, but the vehicle 101 may be a four-wheeled vehicle.

The user communication device 103 is, for example, a smartphone owned by the user 102 or lent by the service provider, and can communicate with the information processing server 100 via a communication network. The user 102 can designate a payment amount (actual payment amount) using the user communication device 103 and transmit information on the payment amount to the information processing server.

### Functional Configuration Example of Information Processing Server

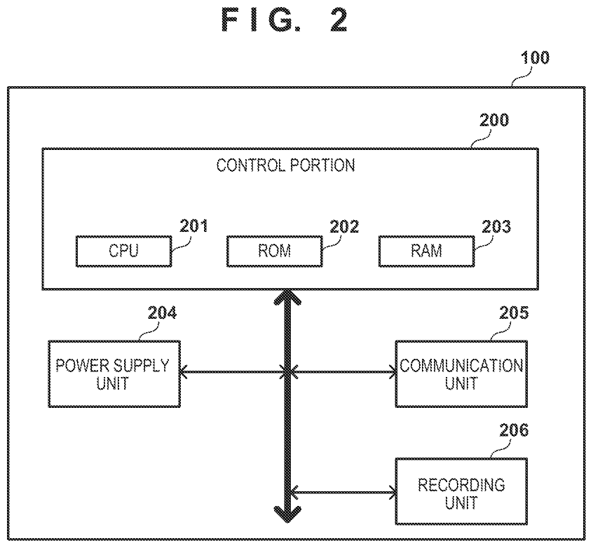

FIG. 2 is a block diagram illustrating a functional configuration example of the information processing server 100. A control portion 200 includes one or more processors (central processing unit (CPU) 201), a read only memory (ROM) 202, and a random access memory (RAM) 203. The CPU 201 reads and executes a computer program (simply referred to as a program) stored in the ROM 202, thereby controlling various processes described below. The ROM 202 is a non-volatile storage area, and stores programs corresponding to the various types of processing. Note that a semiconductor memory may be used instead of the HDD. The RAM 203 is a volatile storage area, and is used as, for example, a working memory. Note that the control portion 200 may include a graphics processing unit (GPU), an application specific integrated circuit (ASIC), a dedicated circuit, or the like. Furthermore, the control portion 200 may be configured such that each constituent element of the control portion 200 is virtualized.

A power supply unit 204 is a part that supplies external power to the information processing server 100. A communication unit 205 is a part that communicates with the vehicle 101, the user communication device 103, and the like via a communication network, and is not particularly limited in terms of a communication method, a communication protocol, and the like.

A recording unit 206 includes, for example, a non-volatile recording medium such as a hard disk drive (HDD), and records and holds various types of information of the DB or the like described above.

[Software Configuration of Information Processing Server]

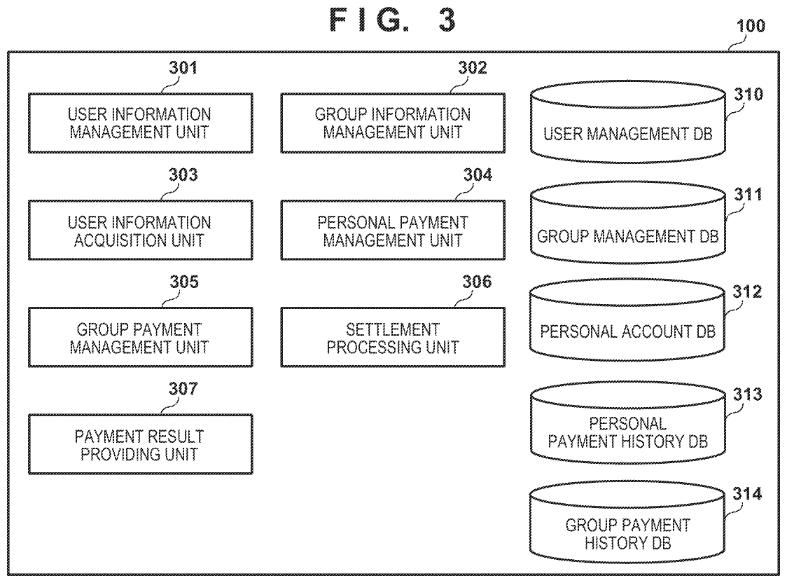

FIG. 3 is a diagram illustrating an example of a software configuration of the information processing server 100 according to the present embodiment. In the present embodiment, the CPU 201 reads and executes a program stored in the ROM 202 or the like to implement each unit. Each database (DB) is included in the recording unit 206. Note that FIG. 3 illustrates only an example of the software configuration necessary for implementation of the present embodiment, so that each software configuration of firmware, OS, middleware, a web service module, and the like is omitted.

A user information acquisition unit 303 acquires user information from the vehicle 101 and the user communication device 103 via the communication unit 205. The user information includes information of a payment amount (actual payment amount) received from the user communication device 103, traveling data uploaded from the vehicle 101, and the like.

The user information management unit 301 is a part that manages the user data acquired by the user information acquisition unit 303 for each user. The user information management unit 301 enables specifying user information, for example, by using the identifier of a user to write the data of the user in a user management DB 310 or read the user information recorded in the user management DB 310.

A group information management unit 302 is a part that manages a formed group and users who are members of the group. The group information management unit 302 enables specifying group information, for example, by using the identifier of a group and associates the group identifier with the identifier of the user who is a member to write the data of the group in a group management DB 311. In addition, the group information management unit 302 reads group information recorded in the group management DB 311 and information on a user who is a member of a specific group.

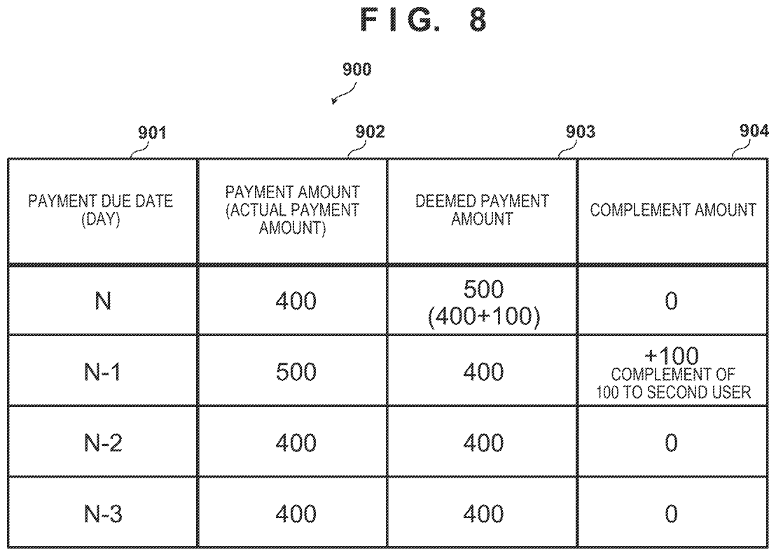

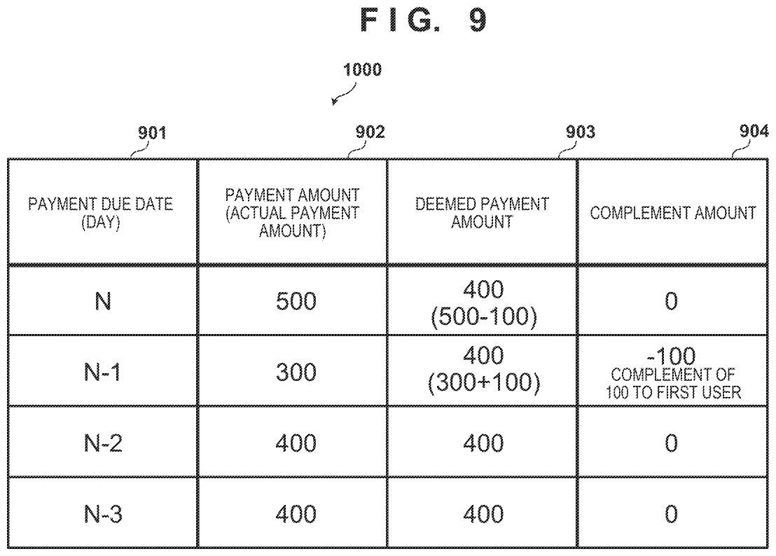

A personal payment management unit 304 is a part that manages payment information for each user. For example, the personal payment management unit 304 determines a deemed payment amount for each user on the basis of payment amounts (actual payment amounts) of a plurality of users forming a group. The personal payment management unit 304 can record information such as a deemed payment amount and other payment amounts in a personal payment history DB 313. In addition, the personal payment management unit 304 reads payment history information recorded in the personal payment history DB 313. The payment information processed by the personal payment management unit 304 will be described later with reference to FIGS. 8 and 9.

A group payment management unit 305 determines a payment status of the entire group, and records a history of the payment amount paid by the entire group in a group payment history DB 314 or reads the history from the group payment history DB 314. In the group payment history DB 314, a predetermined amount to be paid by the entire group, the number of counts for a case where the payment amount of the entire group does not satisfy the predetermined amount, and the like are recorded in addition to the history of the payment amount paid by the entire group.

A settlement processing unit 306 is a part that accesses information of a personal account recorded in a personal account DB 312 and executes a transaction process for a complement amount and a deemed payment amount when the actual payment of each user and the adjustment (complement or return) of the payment amount are executed as an actual payment transaction. The personal account DB 312 may further record a history of transactions for each user. The history of transactions may be recorded using, for example, a blockchain technology, and recording using the blockchain can reduce a risk that the record of each transaction is falsified illegally.

When the payment of each user is completed, a payment result providing unit 307 can create, for example, information (payment result information) for the user to confirm the deemed payment amount or complement amount which is set for the payment amount (actual payment amount) of the user. Then, the payment result providing unit 307 can transmit the created payment result information to the user communication device 103 (via the communication unit 205).

[Overview of Payment Information and Payment Amount Control Process]

As described above, for example, the personal payment management unit 304 determines a deemed payment amount for each user on the basis of payment amounts (actual payment amounts) paid by a plurality of users forming a group. The payment information includes a deemed payment amount and a complement amount determined by the personal payment management unit 304. FIG. 8 illustrates payment information 900 of a first user belonging to the group. The payment information includes, for example, a field of a payment due date 901, a field of a payment amount (actual payment amount) 902, a field of a deemed payment amount 903, and a field of a complement amount 904.

The payment due date indicates the period of each payment (for example, every day, every month). In the present embodiment, the payment due date is set for each day. That is, it is assumed that the user pays, as the rental cost of the vehicle 101, a predetermined amount (personal payment amount) to be paid by each user on each due date. In the example of FIG. 8, the payment due date 901 indicates N to N−3 and indicates the due dates of past three days in addition to N day with the current day as N.

The payment amount (actual payment amount) 902 indicates a payment amount paid by the first user using the user communication device 103 on the payment due date (for example, N day). The payment amount (actual payment amount) 902 is an amount that can be arbitrarily designated by the user. For example, in a case where the personal payment amount for the vehicle rental cost is 400 (the unit of currency is arbitrary), it is desirable that the first user designates a payment amount (actual payment amount) of 400 or more in order to continue the payment. When the first user designates a payment amount (actual payment amount) of 400 or more, at least the amount to be paid by the first user on N day is paid.

Note that, in the present embodiment, the information processing server 100 includes an account DB. However, the account DB may be provided in a third party server. That is, payment may be made in the account DB of the third party server on the basis of the information from the communication device 103, and the information processing server 100 may perform payment information management on the basis of the information from the third party server.

The deemed payment amount 903 is different from the payment amount (actual payment amount) 902 that can be designated by the user, is an amount determined by a payment amount calculation process of the information processing server 100, and indicates a payment amount that the first user is considered to have paid as his/her own rental cost on a specific due date (for example, N day).

The complement amount 904 indicates a cumulative total of a complement amount provided by the first user for the shortage of another second user who cannot pay the personal payment amount or a complement amount provided by another second user for the shortage of the first user who cannot pay the personal payment amount.

A more specific description will be given with reference to the examples of FIGS. 8 and 9. Note that FIG. 9 illustrates the payment information of the second user. It is assumed that the personal payment amount is set to 400.

For example, attention is paid to the payment on N−1 day. In a case where the payment due date is N−1, as illustrated in FIG. 8, the first user designates 500 as the payment amount (actual payment amount). This amount is an amount exceeding 400 which is a personal payment amount. On the other hand, in a case where the payment due date is N−1, the second user designates only 300 as the payment amount (actual payment amount) as illustrated in FIG. 9. That is, it is assumed that the second user happens to fail to pay 400, which is the personal payment amount, on N−1 day due to a fluctuation in payment ability.

In a case where such a payment amount (actual payment amount) is designated, in the payment amount control process, the deemed payment amount for the first user is set to 400, and the remaining 100 is used as a complement amount to complement the payment of the second user. Therefore, the deemed payment amount of the second user on N−1 day is 300+100=400, and it is considered that the second user can make the payment of 400 corresponding to the personal payment amount. Since the second user has received 100 as a complement amount from the first user, the complement amount 904 is “−100” indicating that the second user has received a complement of 100 from the first user. Conversely, the complement amount 904 of the first user is “+100” indicating that the first user makes a complement of 100 for the second user.

Further, an example will be described in which the payment due date is N day, and the second user returns the complement amount. In a case where the payment due date is N day, for example, the first user designates 400 as the payment amount (actual payment amount), and the second user designates 500 as the payment amount (actual payment amount).

For example, in a case where the deemed payment amount of the second user is calculated, first, the complement amount (that is, 100) is subtracted from 500 which is the payment amount (actual payment amount). This is because the complement amount is returned to the first user. Accordingly, the deemed payment amount of the second user becomes 400, and the complement amount returns to 0.

On the other hand, the deemed payment amount of the first user is 500 (=400+100) since 400 which is the payment amount (actual payment amount) is added with the complement amount (that is, 100) returned by the second user.

As described above, in the payment amount control process, the information processing server 100 calculates the deemed payment amount and the complement amount according to the payment amount (actual payment amount) of the user in the group. Accordingly, even when the payment amount of a specific user temporarily does not reach the personal payment amount, adjustment can be performed using the payment amount of another user. Therefore, even in a case where the payment is delayed, and the credit of the user is lowered when the user makes the payment alone, the payment can be safely continued.

[Traveling Data]

The traveling data is managed for each user and generated for each user when the traveling data is acquired from the vehicle 101. The traveling data may include a starting time and an ending time of driving by the user, time-series data indicating a transition of the position of the vehicle between the starting time and the ending time, time-series data indicating a transition of the speed of the vehicle between the starting time and the ending time, and time-series data indicating a transition of the acceleration of the vehicle between the starting time and the ending time. In addition, information indicating whether the vehicle has traveled without maintenance in an appropriate period may be added to the traveling data.

[Group of Users]

As described above, in the group management DB 311, the information on users forming a group and the information on the group are managed. The group may be generated in any manner. For example, a specific user may use the user communication device 103 to invite another user to form a group with the user who has accepted the invitation.

Alternatively, the information processing server 100 may perform a matching process of a user on a large number of users registered in the service provider and recommend, to a specific user, another user suitable for forming a group with the user.

For example, the service provider can provide a housekeeping account-book application to the user of the user communication device 103 in advance to enable the user to input a daily balance. In this case, the information processing server 100 receives and accumulates data of revenue and expenditure transmitted from the user communication device 103, and specifies the payment ability of each user on the basis of the data. For example, a user with a payment ability which is on average above a personal payment amount for a predetermined period of time (for example, a period of time during which the user generally rents a vehicle) is specified, and the specified user is recommended as a candidate for a group member.

The present invention is not limited to a case where the average payment ability of each user exceeds the personal payment amount as described above. When the average payment ability of members forming a group exceeds a group payment amount (for example, 2000 in a group of 5 persons), the members may be recommended as candidates. In this manner, in a case where the members having average payment ability exceeding the group payment amount are recommended, for example, a combination of a user having a high average payment ability and a user having a slightly low average payment ability can be recommended.

The information processing server 100 may cluster users having similar quality levels in a traveling area, a behavior pattern in one day, or a maintenance state of the vehicle on the basis of the acquired traveling data or position information from the communication device 103. In this case, after clustering the users, the information processing server 100 may recommend a user having an average payment ability of an individual or a payment ability of a group exceeding a reference value.

### Functional Configuration Example of User Communication Device 103

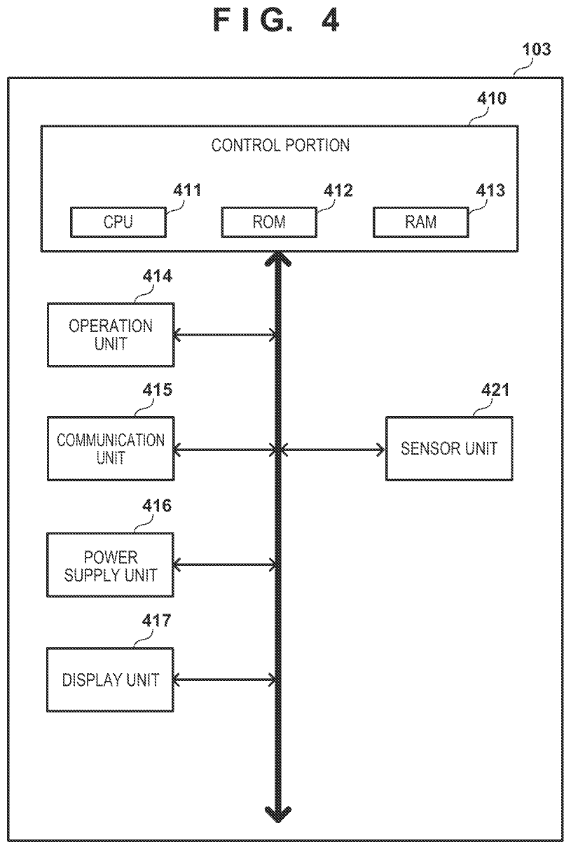

Next, a functional configuration example of the user communication device 103 will be described. FIG. 4 is a block diagram illustrating the functional configuration example of the user communication device 103. A control portion 410 includes one or more CPUs 411, a ROM 412, and a RAM 413. The CPU 411 reads and executes a program stored in the ROM 412 to control various types of processing in the communication device. The program may include the housekeeping account-book application described above. The ROM 412 is a non-volatile storage medium, and for example, a semiconductor memory is used to store programs corresponding to various types of processing. The RAM 413 is a volatile storage medium, and is used as, for example, a working memory. Note that the control portion 410 may include a GPU, an ASIC, a dedicated circuit, or the like.

The user communication device 103 according to the present embodiment includes an interface of information for the outside and various parts that provide power necessary for the operation of the user communication device 103, and the like. Each part to be described below operates under the control of the control portion 410. An operation unit 414 is a part that receives various operations on the communication device, and includes, for example, a switch and a touch panel. In the present embodiment, for example, the operation unit 414 receives the input of the payment amount (actual payment amount) of each user, the input of the balance to the housekeeping account-book application, and the like described above.

A communication unit 415 is a part for communicating with an external device (for example, the information processing server 100) via a network, and is not particularly limited in terms of a communication method, a communication protocol, and the like. For example, the communication unit 415 transmits the payment information and the like input by the user to the information processing server 100 or receives the payment result information and the like generated by the information processing server 100.

A power supply unit 416 is a part that supplies power to each unit of the user communication device 103 and corresponds to a battery. The display unit 417 includes a screen for inputting payment, a screen for displaying payment result information, a display for displaying map data for navigation, and the like. The display unit 417 and the operation unit 414 may be integrally configured as, for example, a touch panel display.

A sensor unit 421 includes various sensors such as a global positioning system (GPS) for detecting its own position information and a camera.

[Configuration of Vehicle 101]

Although the configuration of the vehicle 101 is not illustrated, the vehicle 101 includes a control portion including one or more CPUs, a storage medium such as a ROM, and a RAM, various sensors such as a GPS and an acceleration sensor, and a communication unit capable of performing wireless communication. The CPU of the vehicle 101 reads and executes a program stored in the recording medium, thereby transmitting data acquired from a sensor in the vehicle as traveling data (via the communication unit) to the information processing server 100.

[Series of Operation Steps of Payment Amount Control Process]

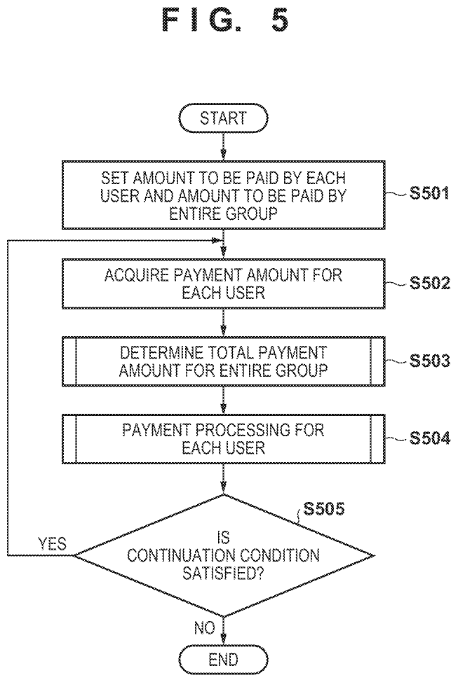

Next, a series of operation steps of the payment amount control process in the information processing server 100 according to the present embodiment will be described with reference to FIG. 5. In the present embodiment, the CPU 201 of the information processing server 100 reads and executes a program stored in the ROM 202 to implement this process. Each processing step is implemented by cooperation of, for example, the parts in FIG. 2 and the processing units in FIG. 3. However, here, for the sake of simplicity, each processing step will be comprehensively described as being performed by the information processing server 100.

In S501, the information processing server 100 sets an amount to be paid by each user on each due date (that is, a personal payment amount) and an amount to be paid by the entire group on each due date (that is, a group payment amount). The group payment amount is, for example, a number obtained by multiplying the personal payment amount by the number of users.

Note that, in the payment amount control process, the number of users belonging to the group can be increased or decreased. Therefore, in response to the increase or decrease in the number of users, the information processing server 100 can change a predetermined amount for group on the basis of the new number of users and the personal payment amount.

In S502, the information processing server 100 acquires information indicating the payment amount of each user from the user communication device 103 associated with each user belonging to the group on the payment due date. The information indicating the payment amount corresponds to the information indicated in the payment amount (actual payment amount) 902 illustrated in FIGS. 8 and 9 described above.

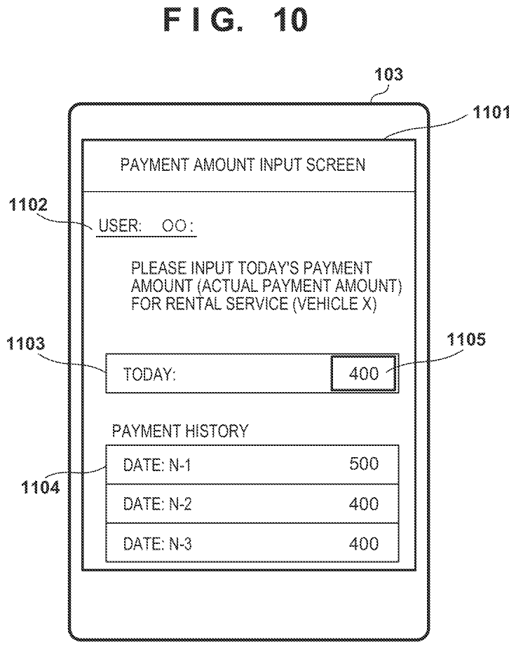

Each user inputs a payment amount on the payment amount input screen illustrated in FIG. 10, for example, in the user communication device 103. A payment amount input screen 1101 illustrated in FIG. 10 includes, for example, a user name display 1102, a today's payment amount input field 1103, a payment amount (actual payment amount) 1105, and a payment history field 114.

When the user inputs a payment amount for today as the payment amount (actual payment amount) 1105 according to his/her own revenue, the payment amount is transmitted to the information processing server 100. The user communication device 103 acquires information of a payment history 1104 related to the deemed payment amount of the user so far from the information processing server 100 and presents the information on the payment amount input screen. The payment history information is generated, for example, by the payment result providing unit 307 of the information processing server 100. In this way, the user can input the payment amount for today while considering the payment history so far. Note that, an example has been illustrated in which the deemed payment amount so far is displayed in the payment history. However, at least one of the history of the deemed payment amount and the payment amount (actual payment amount) and the complement amount may be further displayed.

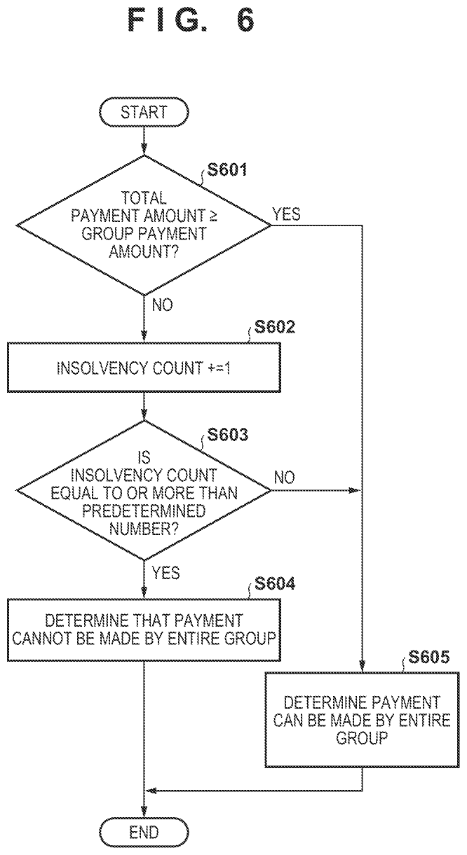

In S503, by determining a total payment amount in the entire group (total payment amount determination process), the information processing server 100 determines whether the total payment amount satisfies a payment continuation condition. The total payment amount determination process will be described later with reference to FIG. 6.

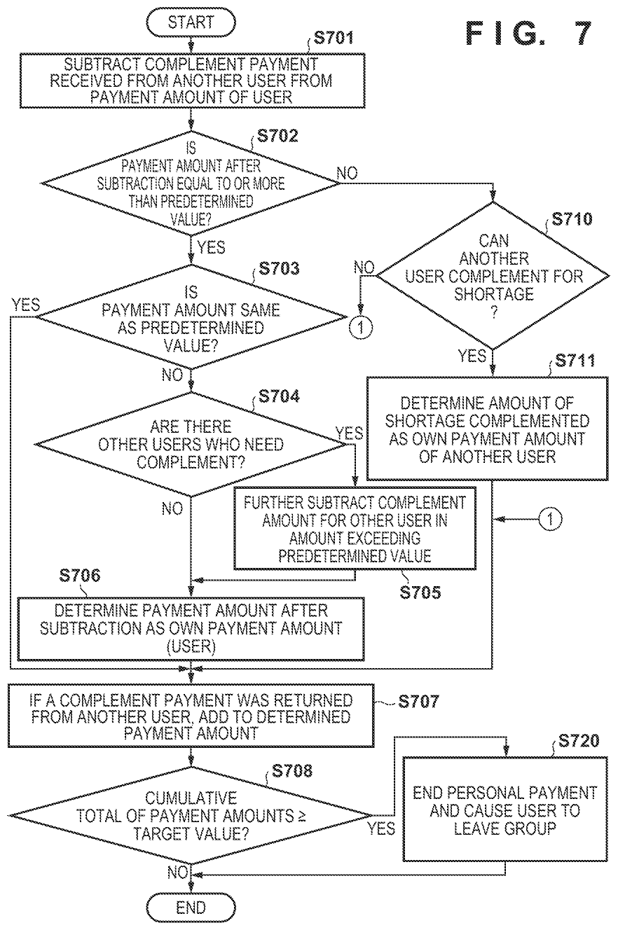

In S504, the information processing server 100 executes a payment process for each user, and determines the deemed payment amount 903 and the complement amount 904 for each user. Note that, in this step, it is assumed that this process is repeatedly called as many times as the number of users belonging to the group. The payment process for each user will be described later with reference to FIG. 7.

In S505, the information processing server 100 determines whether this process satisfies the continuation condition on the basis of the processing result of the total payment amount determination process in S503. For example, the information processing server 100 refers to flag information (described later) indicating that payment cannot be continued in the entire group, and determines whether it is determined that payment cannot be made by the entire group in S503. In a case where it is determined in S503 that payment cannot be made by the entire group, it is determined that the continuation condition is not satisfied, and this series of operation steps are ended. In addition, even in a case where all the users forming the group end or stop the payment and leave the group, it is determined that the continuation condition is not satisfied, and this series of operation steps are ended. Otherwise, the information processing server 100 returns the processing to S502 and repeats the processing.

[Series of Operation Steps of Total Payment Amount Determination Process]

Next, a series of operation steps of the total payment amount determination process will be described with reference to FIG. 6. Similarly to the payment amount control process described above, this process is implemented by the CPU 201 of the information processing server 100 reading and executing a program stored in the ROM 202. Each processing step is implemented by cooperation of, for example, the parts in FIG. 2 and the processing units in FIG. 3. However, here, for the sake of simplicity, each processing step will be comprehensively described as being performed by the information processing server 100. This process is read when the processing in S503 is executed.

In S601, the information processing server 100 determines whether the total amount of the payment amounts (actual payment amount) of the users in the group acquired in S502 is equal to or more than the amount to be paid by the entire group (that is, the group payment amount). In a case where the total amount of the payment amounts (actual payment amounts) of the users in the group is equal to or more than the group payment amount (for example, 2000 in a group of 5 persons), the information processing server 100 proceeds to S605. Otherwise, the total amount of the payment amounts (actual payment amount) of the users in the group does not satisfy the group payment amount, and thus the process proceeds to S602.

In S602, the information processing server 100 increments an insolvency count for counting the number of times the payment amounts of the users in the group do not satisfy the group payment amount by one (note that this insolvency count is initialized to 0).

In S603, the information processing server 100 determines whether the insolvency count is equal to or more than a predetermined number. In a case where the insolvency count is equal to or more than the predetermined number, the information processing server 100 proceeds to S604 and determines that the payment cannot be continued in the entire group. At this time, for example, the information processing server 100 sets the flag information indicating that the payment cannot be continued in the entire group to one. In other words, in a case where the number of times the payment amounts of the plurality of users as the entire group do not satisfy the group payment amount is equal to or more than the predetermined number, the information processing server 100 performs a process of stopping payment for each due date by the plurality of users (that is, this series of processing).

On the other hand, in a case where the insolvency count is less than the predetermined number of times, the information processing server 100 proceeds to S605 and determines that (continuation of) payment can be made by the entire group. At this time, for example, the information processing server 100 sets the flag information indicating that the payment cannot be continued in the entire group to 0. Thereafter, the information processing server 100 returns the processing to the calling source.

[Series of Operation Steps of Payment Process for Each User]

Next, a series of operation steps of the payment process for each user will be described with reference to FIG. 7. Similarly to the payment amount control process described above, this process is implemented by the CPU 201 of the information processing server 100 reading and executing a program stored in the ROM 202. Each processing step is implemented by cooperation of, for example, the parts in FIG. 2 and the processing units in FIG. 3. However, here, for the sake of simplicity, each processing step will be comprehensively described as being performed by the information processing server 100. Note that, in this process, processing for one user is described as an example for convenience of description. Actually, in this process, the process is repeatedly executed as many times as the number of the users belonging to the group.

In S701, the information processing server 100 subtracts (that is, returns) the complement amount received from another user from the payment amount (actual payment amount) of the user. Referring to FIG. 9, this processing corresponds to the calculation of the deemed payment amount (for example, 500-100) in a case where the payment due date is N.

Note that, in this example, a case where the number of users who the complement amount is to be made is one is described as an example. However, in a case where there are a plurality of users who the complement amount is to be made, information on the users who the complement amount is to be made may be transmitted to the user communication device 103, and the user who the complement amount is to be made may be determined in response to acquisition of the selection by the user. Furthermore, in a case where there are a plurality of users who the complement amount is to be made, the information processing server 100 may select to which user the return is to be made. For example, the complement may be made for a user with a high priority according to a predetermined priority order, for example, by selecting a user who has been provided with the largest complement amount among the plurality of users.

In S702, the information processing server 100 determines whether the payment amount after the subtraction is equal to or more than a predetermined value (here, corresponding to the personal payment amount). In a case where the information processing server 100 determines that the payment amount after the subtraction is equal to or more than the predetermined value, the processing proceeds to S703, and otherwise, the processing proceeds to S710.

In S703, the information processing server 100 determines whether the payment amount after the subtraction is the same as the predetermined value (personal payment amount). In a case where the payment amount after the subtraction is the same as the predetermined value (personal payment amount), the payment amount after the subtraction is in a state of having no excess or deficiency with respect to the personal payment amount, and thus, the payment amount is neither to complement the payment of another user nor to be complemented by the payment of another user. Therefore, the information processing server 100 advances the processing to S707. On the other hand, in a case where the payment amount after the subtraction exceeds the predetermined value, the information processing server 100 can make a complement for another user, and thus the processing proceeds to S704.

In S704, the information processing server 100 determines whether there is another user who needs a complement in the group. In a case where the information processing server 100 determines that there is another user who needs a complement in the group, the processing proceeds to S705, and otherwise, the processing proceeds to S706.

Note that, in this example, a case where the number of other users who need a complement is one has been described as an example. However, in a case where there are a plurality of other users who need a complement, information on the user who needs a complement may be transmitted to the user communication device 103, and the user for whom a complement is made may be determined in accordance with acquisition of selection by the user. Furthermore, in a case where there are a plurality of other users who need a complement, the information processing server 100 may select the user for whom a complement is made. For example, the complement may be made for a user with a high priority according to a predetermined priority order, for example, by selecting a user who needs the largest complement amount among the plurality of users.

In S705, the information processing server 100 provides the complement amount necessary for the other user from the amount exceeding the personal payment amount in the payment amount after the subtraction in S703. Therefore, the complement amount for the other user in the amount exceeding the personal payment amount is subtracted from the payment amount obtained in S701.

In S706, the information processing server 100 determines the payment amount after the subtraction as its own payment amount. That is, the information processing server 100 determines, as the deemed payment amount of the user, an amount which is an amount obtained by subtracting the complement amount and is equal to or more than the personal payment amount. This processing corresponds to, for example, on N−1 day in FIG. 8, the deemed payment amount of the first user is determined as 400 after subtracting the complement amount (100) for the second user.

In S707, the information processing server 100 determines whether there is a complement amount returned from another user in the group, and in a case where there is a returned complement amount, the complement amount is adds to the deemed payment amount determined in S706. That is, in a case where a complement amount is returned, the deemed payment amount of the user who has provided the complement amount is determined on the basis of the deemed payment amount of the user determined in S706 and the returned complement amount. Note that S707 may be performed between S701 and S702.

Note that the processing of S707 corresponds to adding the complement amount returned by the second user to the deemed payment amount for the first user on N day in FIG. 8.

In order to motivate payment of a personal payment amount or more, additional services may be provided to a user whose cumulative total of deemed payment amounts has reached a target value. That is, in S708, the information processing server 100 determines whether the cumulative total of the deemed payment amounts of the user so far (that is, in the example of FIG. 8, the cumulative total of the deemed payment amounts on N−3 to N days) is equal to or more than a predetermined target value. A user who has reached the predetermined target value is provided with, for example, a service which enables the user to end the payment and take delivery of the vehicle.

In a case where the information processing server 100 determines that the cumulative total of the deemed payment amounts exceeds the predetermined target value, the processing proceeds to S720. In S720, the information processing server 100 ends the personal payment by the user and causes the user to leave the group. That is, the user ends the payment in the group, and one member of the group is reduced. On the other hand, in a case where it is determined in S708 that the cumulative total of the deemed payment amounts of the user so far is not equal to or more than the predetermined target value, the processing returns to S504 which is the calling source.

In S710, the information processing server 100 determines whether another user can make a complement for the shortage. That is, in a case where it is determined as No in S702, it means that the payment amount after the subtraction does not satisfy the personal payment amount, and thus, it is determined whether another user can make a complement to achieve the personal payment amount. In a case where the information processing server 100 determines that another user can make a complement for the shortage, the processing proceeds to S711, and otherwise, the processing proceeds to S707 without performing anything.

In S711, the information processing server 100 determines, as the deemed payment amount, an amount obtained when the complement amount from another user is provided for the shortage of the user to be processed. At this time, the complemented payment amount is determined such that the deemed payment amount of the user to be processed is the same as the personal payment amount. In this way, the user to be processed can satisfy the personal payment amount, while the user who makes the complement can be prevented from unnecessarily reducing the payment amount. In the example illustrated in FIG. 9, this processing corresponds to receiving a complement from the first user when a shortage occurs in the payment amount of the second user on N−1 day. When the processing of S711 ends, the information processing server 100 advances the processing to S707 described above.

As described above, in the payment processing for each user, it is determined whether the first payment amount of the first user exceeding the personal payment amount (Yes in S702 and No in S703) and the second payment amount of the second user not satisfying the personal payment amount are included in the information of the payment amount for each user confirmed in S502 (Yes in S704). Then, in a case where it is determined that the first payment amount and the second payment amount are included, the payment amounts of the first user and the second user are determined such that the second payment amount of the second user is complemented by a part of the first payment amount of the first user (S705) (S707 and S711).

While the payment is made as a group with such an operation, even when not satisfying the personal payment amount on a specific payment due date, the user can obtain a complement for payment from another user in the group. In addition, when his/her own payment amount exceeds the personal payment amount, the user can complement the payment of another user who does not satisfy the personal payment amount. That is, it is possible to further reduce a risk in payment for a user having a fluctuating payment ability.

Note that, in the above description, an example has been described in which the user is lent the vehicle, accumulates the payment amount while paying the lending cost, and takes delivery of the rental vehicle when the accumulated payment amount reaches the target amount. However, the present embodiment is not limited to the example of taking delivery of the vehicle. That is, other products other than the vehicle may be targeted. Further, the additional service is not limited to the delivery of the lent product, and another service such as delivery of a product different from the lent product or provision of a unit (point) having economic value may be provided. In addition, the present invention is not limited to a case where a product is lent, and can also be applied to payment of a loan that makes a certain payment every predetermined due date.

In the above-described embodiment, in S708, the information processing server 100 determines whether the cumulative total of the deemed payment amounts of the user so far (that is, in the example of FIG. 8, the cumulative total of the actual payment amounts on N−3 to N days) is equal to or more than the predetermined target value. However, it may be determined whether the result, which is obtained when the cumulative total of the deemed payment amounts is added with the complement amount which has been provided to complement the payment of another user but has not yet been returned, is equal to or more than the target value. In this way, the target can be achieved more quickly on the basis of the amount of money that the user has already paid. In addition, it may be determined whether the result, which is obtained when the complement amount which has been provided from the payment of another user and has not yet been returned is subtracted from the cumulative total of the actual payment amounts, is equal to or more than the target value. In this way, it is possible to motivate the return of the complement amount provided from the payment of another user. In other words, it may be determined whether the cumulative total of the actual payment amounts is equal to or more than the predetermined target value.

### Summary of Embodiments

1. The information processing server according to the above embodiment is an information processing server (for example, 100) which manages periodic payment of a plurality of users belonging to a group, the server including:

a setting unit (for example, 304, S501) that sets a predetermined personal amount to be paid on a predetermined due date by each of the plurality of users;

an acquisition unit (for example, 304, S502) that acquires information indicating payment amounts respectively designated by the plurality of users for each predetermined due date; and

a determination unit (for example, 304, S706 and S711) that determines, in a case where the information acquired by the acquisition unit includes a first payment amount of a first user exceeding the predetermined personal amount and a second payment amount of a second user not satisfying the predetermined personal amount, deemed payment amounts of the first user and the second user such that the second payment amount of the second user is complemented by a part of the first payment amount of the first user.

According to this embodiment, it is possible to further reduce a risk in payment for a user having a fluctuating payment ability.

2. In the information processing server of the above embodiment,

the determination unit makes a complement for the second payment amount of the second user such that an amount determined as the deemed payment amount of the second user is the same as the predetermined personal amount (for example, S711).

According to this embodiment, a user who makes payment not satisfying the predetermined personal amount can satisfy the personal payment amount, while a user who makes the complement can be prevented from unnecessarily reducing the payment amount.

3. In the information processing server of the above embodiment,

the determination unit determines an amount, which is an amount obtained by subtracting the part used as the complement and is equal to or more than the predetermined personal amount, as the deemed payment amount of the first user (for example, S706).

According to this embodiment, the user who makes the complement can accumulate an amount exceeding the predetermined personal amount as his/her own payment, and thus the target value can be reached quickly.

4. In the information processing server of the above embodiment,

the determination unit determines the deemed payment amount of the second user by subtracting the part used as the complement for the second user in order to return the part used as the complement for the second user to the first user according to the second payment amount designated by the second user on a next predetermined due date (for example, S701).

According to this embodiment, the complemented amount of the payment is returned, and thus it is possible to reduce a sense of resistance to make a complement to another user in the group.

5. In the information processing server of the above embodiment,

in a case where the part used as the complement for the second user is returned from the second user to the first user on the next predetermined due date, the determination unit determines the deemed payment amount of the first user on the basis of the first payment amount of the first user and the part returned from the second user (for example, S707).

According to this embodiment, the user who makes the complement can accumulate the result obtained when his/her own deemed payment amount is added with the return amount, and thus the target value can be reached quickly.

6. In the information processing server of the above embodiment,

the setting unit is further capable of setting a predetermined amount for group to be paid on each predetermined due date by the plurality of users as the entire group (for example, S305 and S501), the server further including:

a stopping unit (for example, 305, S604) that stops, in a case where the number of times a payment amount of the entire group of the plurality of users does not satisfy the predetermined amount for group is equal to or more than a predetermined number, payment made on each predetermined due date by the plurality of users.

According to this embodiment, when the payment ability of the entire group is low, it is possible to stop the payment of the group and reduce the loss of the service provider.

7. In the information processing server of the above embodiment,

the setting unit changes the predetermined amount for group on the basis of the number of new users and the predetermined personal amount according to an increase or a decrease in the number of the plurality of users.

According to this embodiment, it is possible to manage the payment ability of the entire group in response to an increase or decrease in the number of users.

The invention is not limited to the foregoing embodiments, and various variations/changes are possible within the spirit of the invention.

What is claimed is:

1. An information processing server which manages periodic payment of a plurality of users belonging to a group, the server comprising:
one or more processors; and
a memory storing instructions which, when the instructions are executed by the one or more processors, cause the information processing server to function as:
a setting unit that sets a predetermined personal amount to be paid on a predetermined due date by each of the plurality of users;
an acquisition unit that acquires information indicating payment amounts respectively designated by the plurality of users for each predetermined due date; and
a determination unit that determines, in a case where the information acquired by the acquisition unit includes a first payment amount of a first user exceeding the predetermined personal amount and a second payment amount of a second user not satisfying the predetermined personal amount, deemed payment amounts of the first user and the second user such that the second payment amount of the second user is complemented by a part of the first payment amount of the first user.

2. The information processing server according to claim 1, wherein the determination unit makes a complement for the second payment amount of the second user such that an amount determined as the deemed payment amount of the second user is the same as the predetermined personal amount.

3. The information processing server according to claim 1, wherein the determination unit determines an amount, which is an amount obtained by subtracting the part used as the complement and is equal to or more than the predetermined personal amount, as the deemed payment amount of the first user.

4. The information processing server according to claim 1, wherein the determination unit determines the deemed payment amount of the second user by subtracting the part used as the complement for the second user in order to return the part used as the complement for the second user to the first user according to the second payment amount designated by the second user on a next predetermined due date.

5. The information processing server according to claim 4, wherein in a case where the part used as the complement for the second user is returned from the second user to the first user on the next predetermined due date, the determination unit determines the deemed payment amount of the first user on a basis of the first payment amount of the first user and the part returned from the second user.

6. The information processing server according to claim 1, wherein
the setting unit is further capable of setting a predetermined amount for group to be paid on each predetermined due date by the plurality of users as the entire group, the server further comprising:
a stopping unit that stops, in a case where the number of times a payment amount of the entire group of the plurality of users does not satisfy the predetermined amount for group is equal to or more than a predetermined number, payment made on each predetermined due date by the plurality of users.

7. The information processing server according to claim 6, wherein
the setting unit changes the predetermined amount for group on a basis of the number of new users and the predetermined personal amount according to an increase or a decrease in the number of the plurality of users.

8. An information processing method executed in an information processing server which manages periodic payment of a plurality of users belonging to a group, the method characterized by comprising:
setting a predetermined personal amount to be paid on a predetermined due date by each of the plurality of users;
acquiring information indicating payment amounts respectively designated by the plurality of users for each predetermined due date; and
determining, in a case where the information acquired by the acquiring includes a first payment amount of a first user exceeding the predetermined personal amount and a second payment amount of a second user not satisfying the predetermined personal amount, deemed payment amounts of the first user and the second user such that the second payment amount of the second user is complemented by a part of the first payment amount of the first user.

9. A non-transitory computer readable storage medium storing a program for causing an information processing server which manages periodic payment of a plurality of users belonging to a group to execute each step of an information processing method, the method comprising:
setting a predetermined personal amount to be paid on a predetermined due date by each of the plurality of users;
acquiring information indicating payment amounts respectively designated by the plurality of users for each predetermined due date; and
determining, in a case where the information acquired by the acquiring includes a first payment amount of a first user exceeding the predetermined personal amount and a second payment amount of a second user not satisfying the predetermined personal amount, deemed payment amounts of the first user and the second user such that the second payment amount of the second user is complemented by a part of the first payment amount of the first user.

10. A service provision support system which includes an information processing server which manages periodic payment of a plurality of users belonging to a group and a plurality of communication devices, wherein
the plurality of communication devices are associated with the plurality of users, respectively, and
the information processing server includes
one or more processors; and
a memory storing instructions which, when the instructions are executed by the one or more processors, cause the information processing server to function as:
a setting unit that sets a predetermined personal amount to be paid on a predetermined due date by each of the plurality of users,
an acquisition unit that acquires information indicating payment amounts respectively designated by the plurality of users for each predetermined due date, and
a determination unit that determines, in a case where the information acquired by the acquisition unit includes a first payment amount of a first user exceeding the predetermined personal amount and a second payment amount of a second user not satisfying the predetermined personal amount, deemed payment amounts of the first user and the second user such that the second payment amount of the second user is complemented by a part of the first payment amount of the first user.
